(19) United States
(12) Patent Application Publication
(10) Pub. No.: US 2017/0078177 A1
(43) Pub. Date: Mar. 16, 2017

(54) METHODS AND APPARATUS FOR VALIDATING RECONFIGURATION MESSAGES BASED ON SDU LIFETIME

(71) Applicant: QUALCOMM Incorporated, San Diego, CA (US)

(72) Inventors: Huan XU, San Diego, CA (US); Xiaojian LONG, Beijing (CN); Tim Tynghuei LIOU, San Diego, CA (US); Yong XIE, Beijing (CN); Xuepan GUAN, Beijing (CN); Jie MAO, Beijing (CN); Shiau-He TSAI, San Diego, CA (US)

(21) Appl. No.: 15/122,748

(22) PCT Filed: Jun. 30, 2014
(86) PCT No.: PCT/CN2014/081099

§ 371 Date: Aug. 31, 2016

(30) Foreign Application Priority Data
Mar. 28, 2014 (CN) PCT/CN2014/074250

(51) Int. Cl. H04L 12/26; H04W 24/08; H04W 24/02

(52) U.S. Cl. CPC H04L 43/0852; H04W 24/02; H04W 24/08; H04W 80/02

(57) ABSTRACT

A method and apparatus for reducing call drop rate by validating reconfiguration messages based on service data unit (SDU) lifetime are described. A receiving device, such as a user equipment, may determine a receiving delay between receiving a first protocol data unit (PDU) and receiving a last PDU of a reconfiguration message SDU. The receiving delay may be compared with an SDU lifetime. The reconfiguration message SDU may be validated based on the comparison of the receiving delay with the SDU lifetime. A receiving delay that is greater than the SDU lifetime may indicate that the SDU is stale and, therefore, invalid. A receiving delay that is less than the SDU lifetime may indicate that the timing of the SDU is valid and the reconfiguration message SDU is to be processed. An activation time of the reconfiguration message SDU may also be honored or disregarded based on the receiving delay.

### CROSS-REFERENCE TO RELATED APPLICATIONS

The present Application for Patent claims priority to PCT Application No. PCT/CN2014/074250 entitled “METHODS AND APPARATUS FOR VALIDATING RECONFIGURATION MESSAGES BASED ON SDU LIFETIME” filed Mar. 28, 2014 and assigned to the assignee hereof and hereby expressly incorporated by reference herein.

### BACKGROUND

Aspects of the present disclosure relate generally to wireless communication systems, and more particularly, to validation of reconfiguration messages.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

A reconfiguration message may become stale due to delays in an over-the-air (OTA) communication link. When a wireless device attempts to implement a stale reconfiguration message, a network node may have already reverted to an original configuration, which results in an out-of-sync state between the wireless device and the network, leading to a reconfiguration failure and possible call drop.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A method and apparatus for reducing call drop rate by validating reconfiguration messages based on service data unit (SDU) lifetime are described. A receiving device, such as a user equipment, may determine a receiving delay between receiving a first protocol data unit (PDU) and receiving a last PDU of a reconfiguration message service data unit (SDU). The receiving delay may be compared with an SDU lifetime. The reconfiguration message SDU may be validated based on the comparison of the receiving delay with the SDU lifetime. A receiving delay that is greater than the SDU lifetime may indicate that the SDU is stale and, therefore, invalid. A receiving delay that is less than the SDU lifetime may indicate that the timing of the SDU is valid and the reconfiguration message should be processed. An activation time of the reconfiguration message may also be honored or disregarded based on the receiving delay.

In one aspect, the disclosure provides a method of wireless communication. The method includes determining a receiving delay between receiving a first PDU and receiving a last PDU of a reconfiguration message SDU. The method further includes comparing the receiving delay with a SDU lifetime; and validating the reconfiguration message SDU based on the comparison of the receiving delay with the SDU lifetime.

Another aspect of the disclosure provides an apparatus for wireless communication. The apparatus includes means for determining a receiving delay between receiving a first PDU and receiving a last PDU of a reconfiguration message SDU; means for comparing the receiving delay with a SDU lifetime; and means for validating the reconfiguration message SDU based on the comparison of the receiving delay with the SDU lifetime.

Yet another aspect of the disclosure provides a computer-readable medium storing computer executable code. The computer-readable medium includes code for: determining a receiving delay between receiving a first PDU and receiving a last PDU of a reconfiguration message SDU; comparing the receiving delay with a SDU lifetime; and validating the reconfiguration message SDU based on the comparison of the receiving delay with the SDU lifetime.

Another aspect of the disclosure provides an apparatus for wireless communication, including at least one processor; and a memory coupled to the at least one processor wherein the at least one processor is configured execute instructions stored in the memory. The at least one processor is configured to: determine a receiving delay between receiving a first PDU and receiving a last PDU of a reconfiguration message SDU; compare the receiving delay with a SDU lifetime; and validate the reconfiguration message SDU based on the comparison of the receiving delay with the SDU lifetime.

These and other aspects of the invention will become more fully understood upon a review of the detailed description, which follows.

### BRIEF DESCRIPTION OF THE DRAWINGS

FIG. 1 is a schematic diagram of a communication network including an aspect of a user equipment that may perform message validation.

FIG. 2 is a flowchart illustrating a method of message validation.

FIG. 3 is a flowchart illustrating another method of message validation.

FIG. 4 is a message diagram illustrating receipt of a reconfiguration message.

FIG. 5 is another message diagram illustrating receipt of a reconfiguration message.

FIG. 6 is a block diagram illustrating an example of a hardware implementation for an apparatus employing a processing system.

FIG. 7 is a block diagram illustrating an example of a telecommunications system.

FIG. 8 is a diagram illustrating an example of an access network.

FIG. 9 is a diagram illustrating an example of a radio protocol architecture for the user and control plane.

FIG. 10 is a block diagram illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In a wireless communication system, a Radio Link Control (RLC) layer may segment a service data unit (SDU) provided by a higher layer into protocol data units (PDU) for transmission. An over-the-air (OTA) communication link may experience delays due to PDU loss and retransmission. Both higher and lower layer protocols such as a radio resource control (RRC) protocol or a physical layer may have timing requirements to coordinate or keep sync with network nodes. For example, a network may require a wireless device to implement radiobearer reconfiguration messages at a certain time in order to keep sync with the physical layer reconfiguration at the network. The term “SDU lifetime” may refer to a time that a receiving wireless device has to implement a change indicated by a reconfiguration message. A delay in the OTA link may result in a reconfiguration message being received at a time when the reconfiguration message has become stale. For example, the complete SDU receipt time may not allow the wireless device to implement the change until after the SDU lifetime. A stale reconfiguration message may no longer be valid for implementation, may be outdated, or the indicated configuration changes may be moot. For example, a reconfiguration message indicating a handover to a target cell may be stale if the network decides to cancel the handover due to lack of response from the wireless device at the target cell in time.

A radio link control (RLC) protocol layer may measure an SDU receiving delay (which may also be referred to simply as a receiving delay) as the time between receipt of a first PDU and a last PDU for a particular SDU. A time of receipt of a PDU may be a time at which a PDU is decoded and/or identified at the RLC layer. The SDU receiving delay may be compared to the SDU lifetime of the particular SDU to determine whether a received reconfiguration message is stale. A stale reconfiguration message may include a reconfiguration message that is received after a time for acting on the reconfiguration message has passed. In an aspect, the stale reconfiguration message may include a reconfiguration message that is received after a time for network node acting on the reconfiguration message has passed and reverted. A stale reconfiguration message may also describe a reconfiguration message considered to be invalid or having an expiration time that has lapsed. Stale reconfiguration messages may be rejected or discarded by the wireless device and, therefore, not processed. The SDU receiving delay may also be used to determine whether to honor (e.g., enforce, apply) or disregard (e.g., ignore) an activation time of the reconfiguration message. An activation time may be an information element within a reconfiguration message indicating a time at which the reconfiguration is to be implemented. In comparison, the SDU lifetime may include a time period after the activation time where late reconfiguration changes are still allowed. If the SDU receiving delay indicates that the activation time has already passed, the wireless device may implement the reconfiguration changes immediately by disregarding the activation time. By validating reconfiguration messages, the wireless device may prevent attempts to change to outdated configurations that may result in dropped calls.

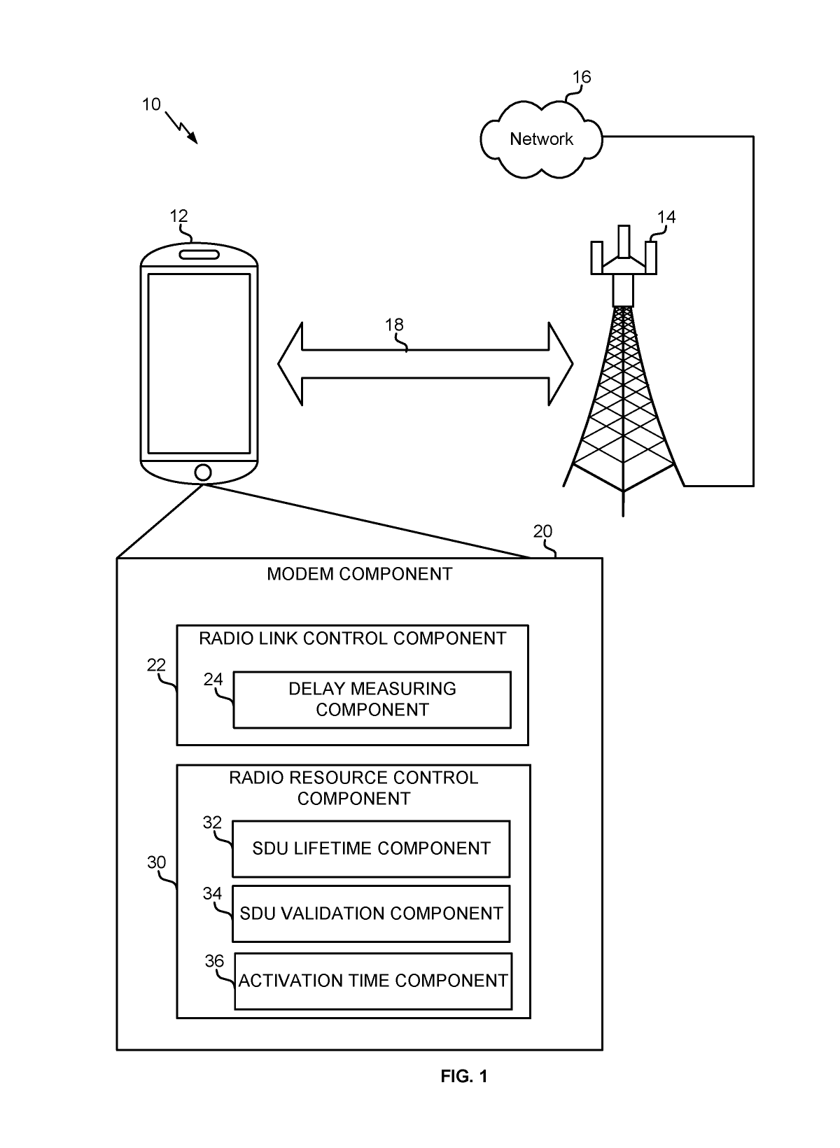

Referring to FIG. 1, in an aspect, a wireless communication system 10 includes at least one UE 12 in communication coverage of at least one network entity 14 (e.g., base station). UE 12 may communicate with network 16 via network entity 14. In some aspects, multiple UEs including UE 12 may be in communication coverage with one or more network entities, including network entity 14. In an example, UE 12 may transmit and/or receive wireless communications to and/or from network entity 14.

In some aspects, UE 12 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, a device for the Internet of Things, or some other suitable terminology. Additionally, network entity 14 may be a macrocell, picocell, femtocell, relay, Node B, mobile Node B, UE (e.g., communicating in peer-to-peer or ad-hoc mode with UE 12), or substantially any type of component that can communicate with UE 12 to provide wireless network access at the UE 12.

According to the present aspects, UE 12 may include modem component 20, which may be configured to validate received messages, particularly reconfiguration messages, by determining whether the messages are stale. The modem component 20 may include a radio link control (RLC) component 22 and a radio resource control (RRC) component 30.

The RLC component 22 may include hardware or means for implementing an RLC protocol. In an aspect, the RLC component 22 may include a processor executing firmware or software for implementing an RLC protocol. The RLC protocol may be described in, for example, 3GPP TS 25.322. The RLC component 22 may control one or more RLC entities. The RLC component 22 may be configured to manage communications across an OTA link. In particular, RLC component 22 may receive an SDU from a higher layer such as RRC component 30 and generate one or more PDUs for transmission on a physical channel. As used herein, transmission by the RLC component 22, may include passing the PDU to a lower layer (e.g., the physical layer) or actual transmission of the PDU on the physical layer to another device. The RLC component 22 may also receive one or more PDUs transmitted by an RLC entity located in the network 16 and assemble the PDUs to form an SDU to pass to the RRC component 30. The RLC component 22 may include a memory or buffer for storing received PDUs while waiting for the remaining PDUs of the SDU to arrive. The RLC component 22 may operate in several modes including transparent mode, unacknowledged mode, and acknowledged mode, providing different levels of confidence in delivery. Further, the RLC component 22 may include a delay measuring component 24.

The delay measuring component 24 may include hardware or means for measuring a receiving delay for an SDU. In an aspect, the delay measuring component 24 may include a processor executing firmware or software for measuring a receiving delay for an SDU. For example, the delay measuring component 24 may include a timer configured to measure the delay between a first received PDU of an SDU and the last received PDU of an SDU. The delay measuring component 24 may inspect a header of a PDU to identify the SDU. The delay measuring component 24 may store the received time when a first PDU for an SDU is received. The delay measuring component 24 may determine the receiving delay of the SDU when the last PDU of the SDU is received and the RLC component 22 assembles the SDU. In an aspect, the delay measuring component 24 may determine a receiving delay for control plane messages such as RRC messages that may be time sensitive. The delay measuring component 24 may identify a control plane SDU once the SDU is reassembled. The delay measuring component 24 may also determine a receiving delay for each SDU upon reassembly.

The RRC component 30 may include hardware or means for implementing a RRC protocol. In an aspect, the RRC component 30 may include a processor executing firmware or software for implementing a RRC protocol. The RRC protocol may be described in, for example, 3GPP TS 25.331. In particular, the RRC component 30 may be configured to receive reconfiguration messages and configure the UE 12 according to the reconfiguration messages. The RRC component 30 may be configured to validate received reconfiguration messages before configuring the UE 12 according to the reconfiguration messages. The reconfiguration messages may be received from the RLC layer as an RLC SDU. An reconfiguration message may also be an RRC PDU, however, for convenience, the term “SDU” will be used to refer to the RLC layer SDU, and the term “PDU” will be used to refer to the RLC layer PDU. The RRC component 30 may include an SDU lifetime component 32, an SDU validation component 34, and an activation time component 36.

The SDU lifetime component 32 may be configured to determine an SDU lifetime for a received reconfiguration message. In an aspect, the SDU lifetime component 32 may be a processor executing firmware or software configured to determine an SDU lifetime for a received reconfiguration message. The received reconfiguration message may be, for example, an RRC protocol message received in an SDU passed from RLC component 22. The SDU lifetime may be a time in which the UE 12 is expected to implement a change preferred by the network 16 in terms of keeping the UE 12 and the network 16 in sync on the configuration of physical channels. In an aspect, the SDU lifetime may be defined by the network 16 either explicitly or implicitly. For example, the network 16 may include a timeout on the network side that provides a time frame for UE configuration changes to take effect. For example, a network may define an SDU lifetime between 6 seconds and 8 seconds from the time the SDU is transmitted by a higher layer, for example, an RRC layer. In one example, the SDU lifetime can be defined in one tenth of a second intervals between 6 seconds and 8 seconds. For example, the SDU lifetime can be defined as 6 seconds, or 6.1 seconds, or 6.2 seconds, and so on until 8 seconds. In another example, the SDU lifetime can be defined in other time intervals, which include but need not be limited to 0.05 second intervals, 0.2 second intervals, 0.25 second intervals, and in non-uniform time intervals between 6 seconds and 8 seconds. If a network node does not receive any indication that the UE 12 has implemented the configuration change before the SDU lifetime expires, the network node may assume that the change did not occur and cancel the change at the network side. As an example, during a handover, if the new cell receives a message from the UE 12 later than expected, the network 16 may have already switched back to the old cell.

The SDU lifetime may be based on a timeout used by the network 16. In an aspect, the network 16 may use a fixed or predetermined timeout period. The SDU lifetime component 32 of UE 12 may be configured with the fixed or predetermined timeout period as the SDU lifetime. The SDU lifetime component 32 may also estimate a fixed timeout period used by the network 16 based on a history of successful and failed reconfiguration attempts. In another aspect, the SDU lifetime may vary based on, for example, the RRC message type or a radio access technology (RAT). The SDU lifetime component 32 may include a look-up table (not shown) for determining an SDU lifetime based on a received RRC message or current RAT. Additionally, the SDU lifetime may not be exactly the same as a timeout on the network side. The SDU lifetime component 32 may determine an SDU lifetime less than the network timeout to allow time for normal transmission time, reconfiguration at the UE 12, and transmitting a response. The SDU lifetime may be further adjusted by a guard interval for a message. The guard interval may increase the SDU lifetime to allow additional time for the UE 12 to implement a change. For example, a guard interval may be added when the network conditions are poor and/or when a configuration change is necessary to prevent a dropped call.

The SDU validation component 34 may be configured to validate a message based on the SDU lifetime and the SDU receiving delay. In an aspect, the SDU validation component 34 may be a processor executing firmware or software configured to validate a message based on the SDU lifetime and the SDU receiving delay. The SDU validation component 34 may determine that a message is stale if the SDU receiving delay exceeds the SDU lifetime. The SDU validation component 34 may determine that a stale message is invalid. The RRC component 30 may be configured to discard, ignore, or otherwise not implement changes indicated by an invalid reconfiguration message. The SDU validation component 34 may, for example, generate a failure message indicating that the received message is invalid. The SDU validation component 34 may generate the failure message based on the received reconfiguration message.

In another aspect, the SDU validation component 34 may determine that a message is valid if the SDU receiving delay is less than or equal to the SDU lifetime. The determination by the SDU validation component 34 may be a preliminary determination. RRC component 30 may perform additional tests to determine the validity of the received reconfiguration message. For example, RRC component 30 may check the contents of the received reconfiguration message before implementing any changes. The RRC component 30 may configure the UE 12 to implement any changes indicated by the reconfiguration message during the SDU lifetime.

The activation time component 36 may be configured to determine whether to honor or disregard the activation time of a message based on the SDU receiving delay. The activation time of the message may be an information element within the message indicating a time at which the reconfiguration is to be implemented. The activation time may be indicated by a connection frame number (CFN). An activation time offset may be a delay until the changes of the message should be implemented. The activation time component 36 may be configured to determine the activation time offset based on the activation time and the received time (or CFN) of the first PDU. For example, the activation time component 36 may be configured to determine the activation time offset by subtracting the CFN of the first PDU from the activation time CFN using modular arithmetic. The activation time component 36 may cause the UE 12 to wait for the activation time before implementing changes in the message. In an aspect, the activation time component 36 may measure the activation time from receipt of the first PDU rather than the receipt of the last PDU or assembly of the SDU. Accordingly, the activation time may indicate the time originally requested by the network for implementing the message. In another aspect, the activation time component 36 may disregard the activation time when the SDU receiving delay exceeds the activation time and immediately implement a change indicated by the message without waiting for the delay associated with the activation time.

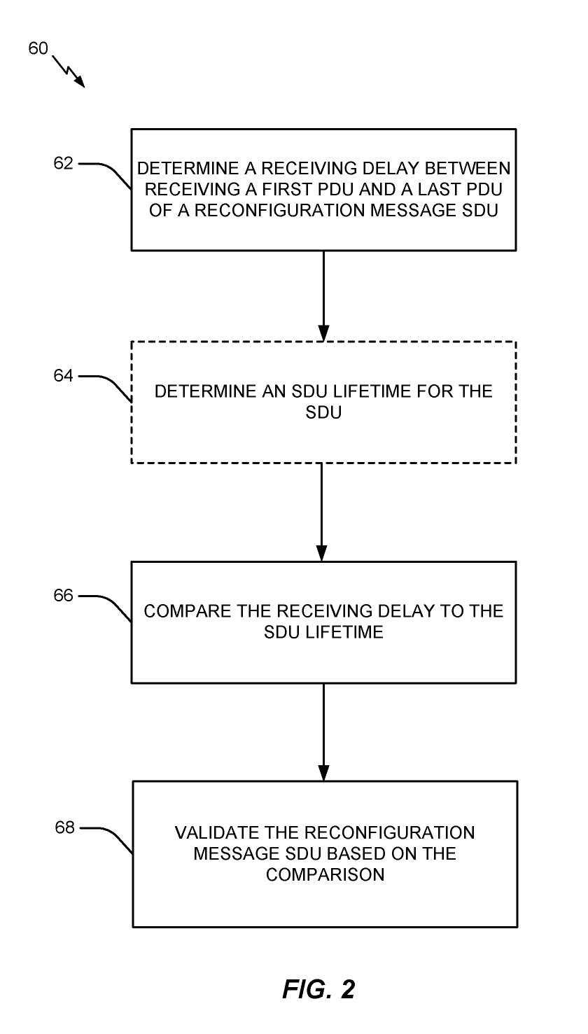

Referring to FIG. 2, in an operational aspect, a UE such as UE 12 (FIG. 1) may perform one aspect of a method 60 for message validation. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, at block 62, the method 60 may include determining a receiving delay between receiving the first PDU and the last PDU of a reconfiguration message SDU. In an aspect, the delay measuring component 24 may determine the receiving delay between receiving the first PDU and the last PDU of the reconfiguration message SDU. The PDUs of an SDU may arrive out of order. Receiving the first PDU may include receiving a first PDU of the SDU at the UE 12 regardless of whether the first received PDU is a first PDU in sequence of the SDU. The delay measuring component 24 (FIG. 1) may record the arrival time of the first PDU or start a timer when the first PDU arrives. The delay measuring component 24 may determine the PDU receiving delay by subtracting the arrival time of the first PDU from the arrival time of the last PDU or a time at which reassembly of the SDU is complete.

At block 64, the method 60 may optionally include determining an SDU lifetime for the received SDU. In an aspect, the SDU lifetime component 32 (FIG. 1) may determine the SDU lifetime for the received SDU. The SDU lifetime component 32 may use a pre-determined SDU lifetime or look up the SDU lifetime based on the contents of the SDU. For example, the SDU lifetime may depend on the type of message included in the SDU. The SDU lifetime component 32 may also adjust the SDU lifetime to include a guard interval if applicable to the SDU.

At block 66, the method 60 may include comparing the SDU receiving delay with the SDU lifetime. The SDU validation component 34 (FIG. 1) may compare the receiving delay with the SDU lifetime. In an aspect, the SDU validation component 34 may determine whether the receiving delay is greater than the SDU lifetime.

At block 68, the method 60 may include validating the SDU based on the comparison of the receiving delay and the SDU lifetime. In an aspect, the SDU validation component 34 (FIG. 1) may validate the SDU based on the comparison of the receiving delay and the SDU lifetime. If the receiving delay is greater than the SDU lifetime, the SDU validation component 34 may determine that the SDU is invalid and reject the SDU. The SDU validation component 34 may generate a response indicating that the received message is invalid or that a reconfiguration has failed. The response may be passed to the RLC component 22 for transmission to the network. If the receiving delay is less than or equal to the SDU lifetime, the SDU validation component 34 may determine that the SDU is valid. The RRC component 30 may continue processing the message or contents contained in the SDU.

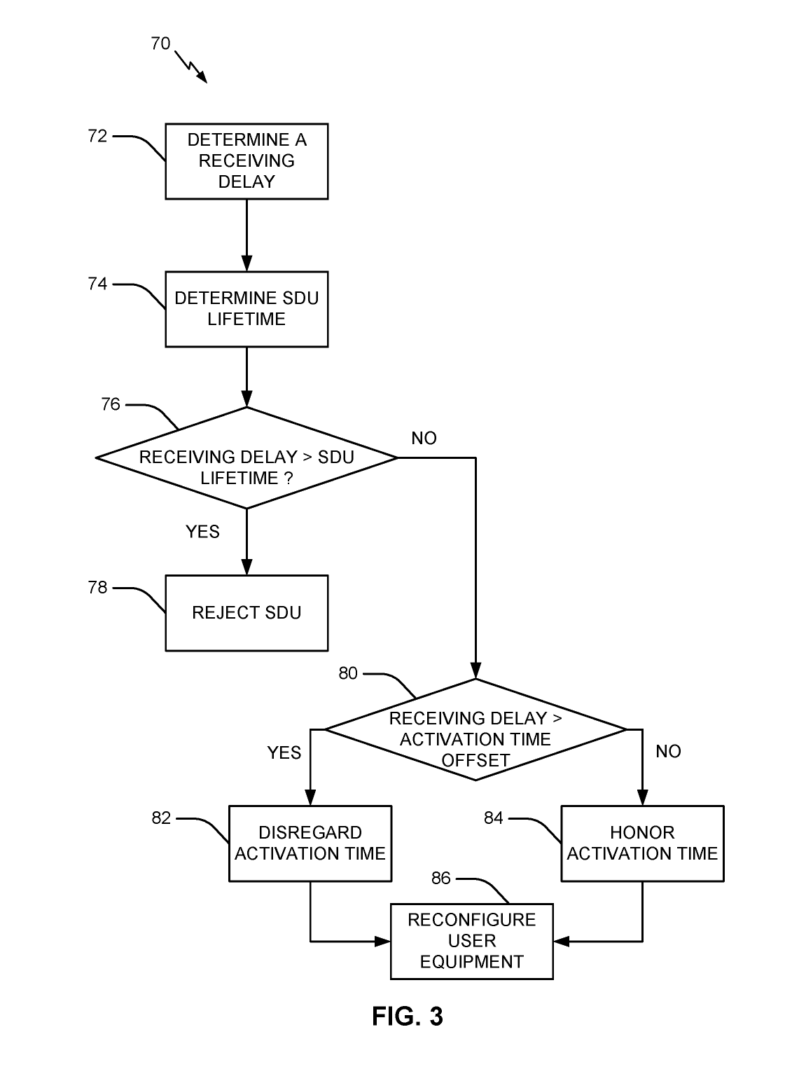

Referring to FIG. 3, in an operational aspect, a UE such as UE 12 (FIG. 1) may perform one aspect of a method 70 for message validation. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, at block 72, the method 70 may include determining a SDU receiving delay between receiving the first PDU and the last PDU of an SDU. Block 72 may be similar to block 62 of method 60 and may be similarly processed by the delay measuring component 24.

At block 74, the method 70 may include determining an SDU lifetime for the received SDU. The block 74 may be similar to the block 64 of method 60 and may be similarly processed by the SDU lifetime component 32.

At block 76, the method 70 may include determining whether the SDU receiving delay is greater than the SDU lifetime. In an aspect, the SDU validation component 34 may determine whether the SDU receiving delay is greater than the SDU lifetime. In another aspect, the SDU validation component 34 may compare the receiving delay determined by the delay measuring component 24 and the SDU lifetime determined by the SDU lifetime component 32. If the receiving delay is greater than the SDU lifetime, the method 70 may proceed to block 78. If the receiving delay is less than or equal to the SDU lifetime, the method 70 may proceed to block 80.

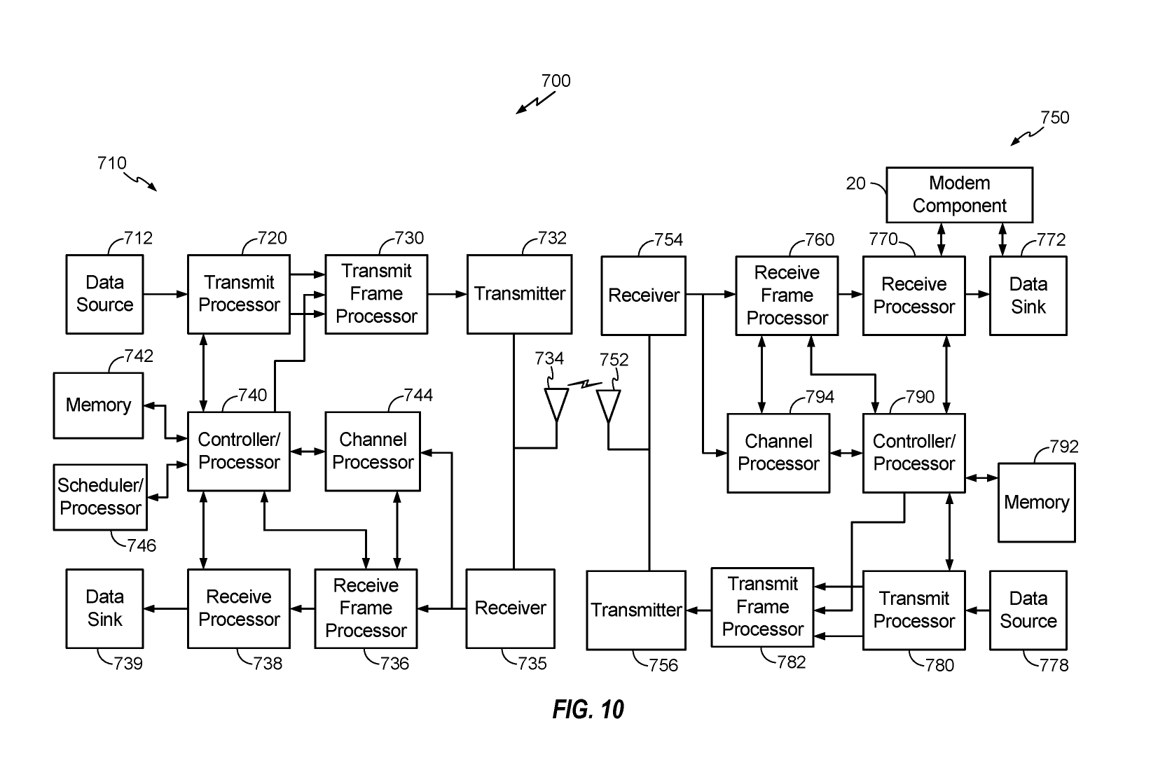

At block 78, the method 70 may include rejecting the received SDU and reconfiguration message. In an aspect, the SDU validation component 34 may reject the received SDU and reconfiguration message. The SDU validation component 34 may determine that the received SDU is invalid. The RRC component 30 may generate a message indicating that the reconfiguration message was rejected. For example, the RRC component 30 may generate a failure response message including an RRC transaction identifier of the reconfiguration message. The specific rejection message may depend on the type of reconfiguration message. The rejection message may include an error code or otherwise indicate that the reconfiguration message was stale. The message may be transmitted via the RRC component 30 and lower layer components (e.g. transmitter 756 (FIG. 10)).

At block 80, the method 70 may include determining whether the receiving delay is greater than an activation time offset. In an aspect, the activation time component 36 may determine whether the receiving delay is greater than an activation time offset. In another aspect, the activation time component 36 may compare the activation time received in the SDU with the CFN of the last received PDU of the SDU. If the receiving delay is greater than the activation time offset, the method 70 may proceed to block 82. If the receiving delay is less than or equal to the activation time, the method 70 may proceed to the block 84.

At block 82, the method 70 may include disregarding the activation time. In an aspect, the activation time component 36 may require no activation delay and allow the UE to immediately implement the change indicated by the message. For example, the activation time indicated by the received reconfiguration message may have already passed. Also, the received reconfiguration message may have included no specific activation time, in which case the activation time component 36 may assume no delay for the activation time.

At block 84, the method 70 may include honoring an activation time. In an aspect, the activation time component 36 may honor the activation time. In another aspect, the activation time component 36 may determine the time to implement the changes indicated in the reconfiguration message of the SDU. The activation time component 36 may cause the RRC component 30 to wait until the activation time before implementing any changes.

At block 86, the method 70 may include reconfiguring the UE 12 based on the received message. In an aspect, the RRC component 30 may reconfigure the UE 12 based on the received message. In another aspect, the RRC component 30 may cause the UE 12 to implement the changes indicated by the received reconfiguration message. The RRC component 30 may also send a response message as part of implementing the changes or to indicate that the changes were successful. The response message sent by the RRC component 30 may depend on the received message. The response message may indicate to the network 16 that the reconfiguration was successful. If the network 16 does not receive the response message within the SDU lifetime, the network 16 may revert to a previous configuration or deny the reconfiguration.

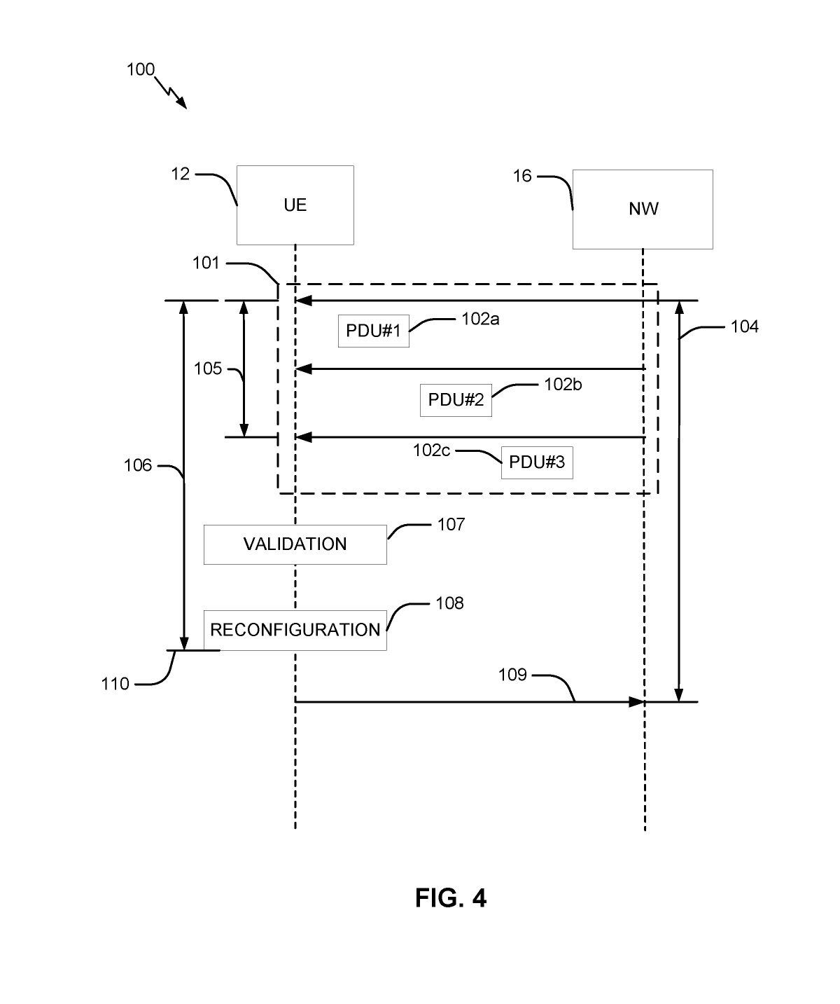

FIG. 4 is message diagram 100 illustrating an example scenario for transmission of a reconfiguration message. An RRC layer of the network 16 (FIG. 1) may generate an RRC reconfiguration message for the UE 12 (FIG. 1). The RRC layer may pass the reconfiguration message to the RLC layer as an SDU. The RLC layer of the network 16 may segment the SDU into a plurality of PDUs 102 for transmission to the UE 12. Each PDU 102 may be transmitted over the air to the UE 12. The network 16 may define an SDU lifetime for the UE to implement the reconfiguration message. The network 16 may measure the SDU lifetime from the time the first PDU 102 is transmitted to the time a response is expected. At the UE 12, an SDU receiving delay 105 may exist between the time the first of the PDUs 102 transmitted by network 16 (PDU 102a) is received and the time the last of the PDUs 102 transmitted by the network 16 (PDU 102c) is received. The time that the first PDU 102a is received may be, for example, a time that the PDU 102a is decoded, identified, and/or processed by the RLC component 22. For example, the RLC component 22 may add a timestamp to a record associated with the PDU 102a when a sequence number of the PDU 102a is identified. In an aspect, the time that the first PDU 102a is received may be a CFN. It should be noted that the PDUs may be received out of order and the terms “first” and “last” may refer to the order in which the PDUs are received rather than the sequence numbers of the PDUs. The SDU 101 formed by assembling the PDUs 102 received by UE 12 may include an activation time offset 106 indicating a delay before implementing the reconfiguration. The activation time offset 106 may be measured from the receipt of the first PDU 102a. In an aspect, the activation time 110 may indicate an absolute time, for example, a CFN when the reconfiguration is to be implemented.

Upon receipt of the last PDU 102c , the UE 12 may reassemble the SDU 101 from the PDUs 102. The UE 12 may perform a validation procedure 107 to determine whether the SDU 101 is stale. The UE 12 may compare the SDU receiving delay 105 with the SDU lifetime 104. As illustrated, the SDU 101 is valid because the SDU receiving delay 105 is less than the SDU lifetime 104. The UE 12 may implement the changes indicated in the reconfiguration message SDU 101 during a reconfiguration process 108. The UE 12 may time the reconfiguration process 108 so that it is completed and takes effect at the activation time 110. If the activation time offset 106 is less than the SDU receiving delay 105 or an absolute activation time 110 is reached before receipt of the last PDU 102c , the UE 12 may disregard the activation time 110 and immediately perform the reconfiguration process 108. The UE 12 may transmit a message 109 indicating the reconfiguration was completed successfully.

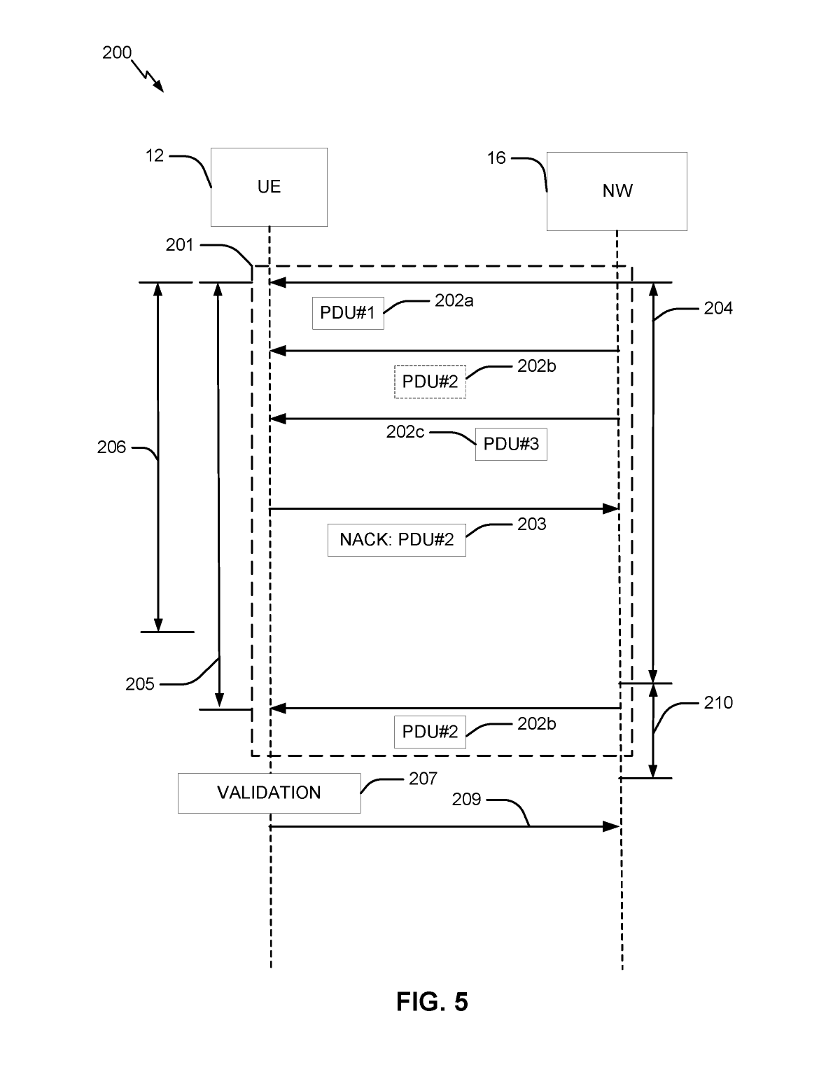

FIG. 5 is another message diagram 200 illustrating an exemplary scenario with an invalid or stale reconfiguration message. Similar to the message diagram 100 of FIG. 4, the network 16 may transmit an SDU 201 as a plurality of PDUs 202. The receiving delay 205 may be relatively long because, for example, one of the PDUs 102b may be received incorrectly and need to be retransmitted. The UE 12 may transmit a negative acknowledgment (NACK) 203 indicating that the PDU 202b was not received correctly. A receiving delay may also be relatively long due to downlink congestion or data loss. Accordingly, the SDU 201 may not be completely received until after the SDU lifetime 204 has elapsed. Accordingly, during the validation procedure 207, the UE 12 may determine that the SDU 201 is stale or invalid because the SDU receiving delay 205 is greater than the SDU lifetime 204. Accordingly, message 209 may indicate that the reconfiguration message SDU 201 is invalid. The UE 12 may refrain from performing a reconfiguration procedure to implement changes indicated by the invalid reconfiguration message SDU 201.

In another aspect, a guard interval 210 may be provided by the network 16 to extend the SDU lifetime 204. The guard interval 210 may be indicated within the SDU 201 or may be based on a message type, activation time, or other characteristic of the SDU 201. If the guard interval 210 extends the SDU lifetime 204 to be greater than the SDU receiving delay 205, the validation procedure 207 may determine that the SDU 201 is valid.

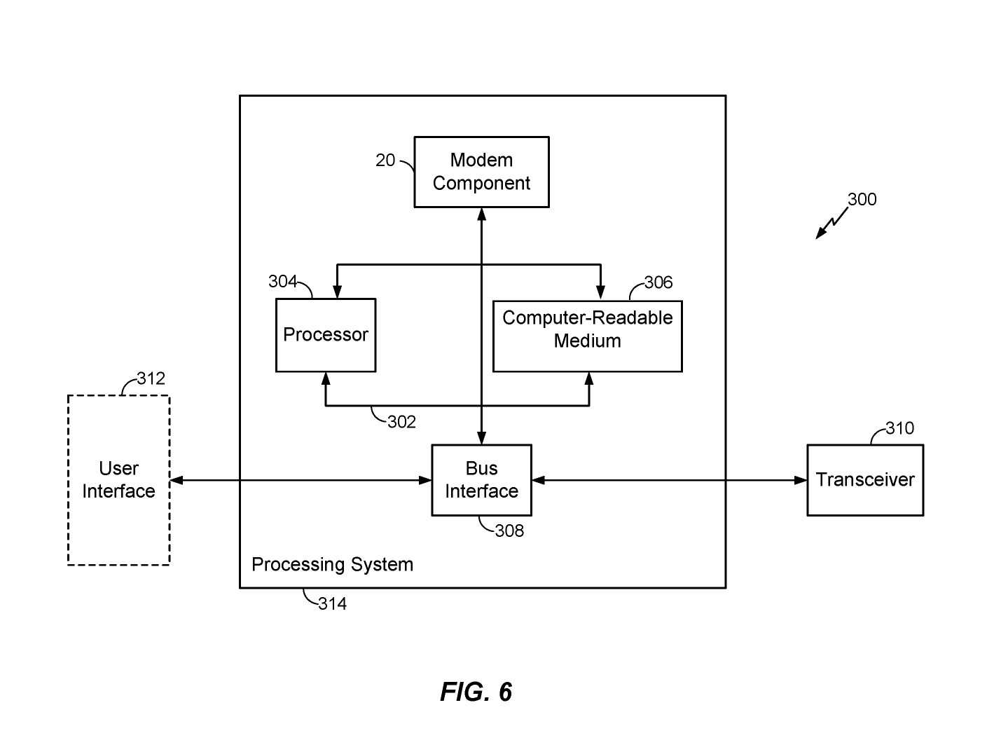

FIG. 6 is a block diagram illustrating an example of a hardware implementation for an apparatus 300 employing a processing system 314. The processing system 314 may include a modem component 20 for validating received reconfiguration messages based on an SDU lifetime. In this example, the processing system 314 may be implemented with a bus architecture, represented generally by the bus 302. The bus 302 may include any number of interconnecting buses and bridges depending on the specific application of the processing system 314 and the overall design constraints. The bus 302 links together various circuits including one or more processors, represented generally by the processor 304, and computer-readable media, represented generally by the computer-readable medium 306. The bus 302 may also link various other circuits such as timing sources, peripherals, voltage regulators, and power management circuits, which are well known in the art, and therefore, will not be described any further. A bus interface 308 provides an interface between the bus 302 and a transceiver 310. The transceiver 310 provides a means for communicating with various other apparatus over a transmission medium. Depending upon the nature of the apparatus, a user interface 312 (e.g., keypad, display, speaker, microphone, joystick) may also be provided.

The processor 304 is responsible for managing the bus 302 and general processing, including the execution of software stored on the computer-readable medium 306. The software, when executed by the processor 304, causes the processing system 314 to perform the various functions described infra for any particular apparatus. The computer-readable medium 306 may also be used for storing data that is manipulated by the processor 304 when executing software. In an aspect, for example, at least a portion of the functions, operations, and/or methods performed by the modem component 20 may be implemented by the processor 304 in cooperation with the computer-readable medium 306.

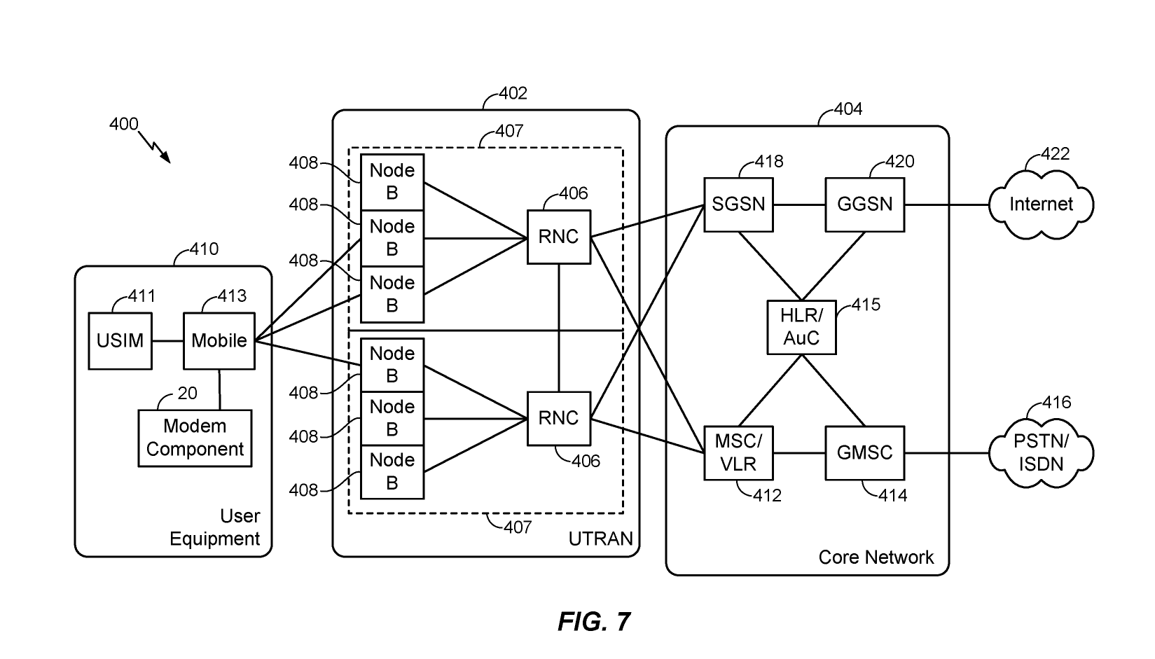

The various concepts presented throughout this disclosure may be implemented across a broad variety of telecommunication systems, network architectures, and communication standards. By way of example and without limitation, the aspects of the present disclosure illustrated in FIG. 7 are presented with reference to a UMTS system 400 employing a W-CDMA air interface. A UMTS network includes three interacting domains: a Core Network (CN) 404, a UMTS Terrestrial Radio Access Network (UTRAN) 402, and User Equipment (UE) 410. The UE 410 may be an example of the UE 12 (FIG. 1) and include a modem component 20 for validating reconfiguration messages based on SDU lifetime. In this example, the UTRAN 402 provides various wireless services including telephony, video, data, messaging, broadcasts, and/or other services. The UTRAN 402 may include a plurality of Radio Network Subsystems (RNSs) such as an RNS 407, each controlled by a respective Radio Network Controller (RNC) such as an RNC 406. Here, the UTRAN 402 may include any number of RNCs 406 and RNSs 407 in addition to the RNCs 406 and RNSs 407 illustrated herein. The RNC 406 is an apparatus responsible for, among other things, assigning, reconfiguring and releasing radio resources within the RNS 407. The RNC 406 may be interconnected to other RNCs (not shown) in the UTRAN 402 through various types of interfaces such as a direct physical connection, a virtual network, or the like, using any suitable transport network.

Communication between a UE 410 and a Node B 408 may be considered as including a physical (PHY) layer and a medium access control (MAC) layer. Further, communication between a UE 410 and an RNC 406 by way of a respective Node B 408 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, The modem component 20 may operate at or between layer 2 and layer 3.

The geographic region covered by the RNS 407 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 408 are shown in each RNS 407; however, the RNSs 407 may include any number of wireless Node Bs. The Node Bs 408 provide wireless access points to a CN 404 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 410 may further include a universal subscriber identity module (USIM) 411, which contains a user's subscription information to a network. The mobile equipment 413 may include any hardware for performing wireless communications with the NodeBs 408. In some aspects, at least a portion of the modem component 20 may be implemented by the mobile equipment 413. In other aspects, at least a portion of the modem component 20 may be implemented in other portions (not shown) of the UE 410. For illustrative purposes, one UE 410 is shown in communication with a number of the Node Bs 408. The DL, also called the forward link, refers to the communication link from a Node B 408 to a UE 410, and the UL, also called the reverse link, refers to the communication link from a UE 410 to a Node B 408.

The CN 404 interfaces with one or more access networks, such as the UTRAN 402. As shown, the CN 404 is a GSM core network. However, as those skilled in the art will recognize, the various concepts presented throughout this disclosure may be implemented in a RAN, or other suitable access network, to provide UEs with access to types of CNs other than GSM networks.

The CN 404 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 404 supports circuit-switched services with a MSC 412 and a GMSC 414. In some applications, the GMSC 414 may be referred to as a media gateway (MGW). One or more RNCs, such as the RNC 406, may be connected to the MSC 412. The MSC 412 is an apparatus that controls call setup, call routing, and UE mobility functions. The MSC 412 also includes a VLR that contains subscriber-related information for the duration that a UE is in the coverage area of the MSC 412. The GMSC 414 provides a gateway through the MSC 412 for the UE to access a circuit-switched network 416. The GMSC 414 includes a home location register (HLR) 415 containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR 415 to determine the UE's location and forwards the call to the particular MSC serving that location.

The CN 404 also supports packet-data services with a serving GPRS support node (SGSN) 418 and a gateway GPRS support node (GGSN) 420. GPRS, which stands for General Packet Radio Service, is designed to provide packet-data services at speeds higher than those available with standard circuit-switched data services. The GGSN 420 provides a connection for the UTRAN 402 to a packet-based network 422. The packet-based network 422 may be the Internet, a private data network, or some other suitable packet-based network. The primary function of the GGSN 420 is to provide the UEs 410 with packet-based network connectivity. Data packets may be transferred between the GGSN 420 and the UEs 410 through the SGSN 418, which performs primarily the same functions in the packet-based domain as the MSC 412 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 408 and a UE 410. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 410 provides feedback to the node B 408 over the HS-DPCCH to indicate whether it correctly decoded a packet on the downlink.

HS-DPCCH further includes feedback signaling from the UE 410 to assist the node B 408 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 408 and/or the UE 410 may have multiple antennas supporting MIMO technology. The use of MIMO technology enables the node B 408 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 410 to increase the data rate or to multiple UEs 410 to increase the overall system capacity. This is achieved by spatially precoding each data stream and then transmitting each spatially precoded stream through a different transmit antenna on the downlink. The spatially precoded data streams arrive at the UE(s) 410 with different spatial signatures, which enables each of the UE(s) 410 to recover the one or more the data streams destined for that UE 410. On the uplink, each UE 410 may transmit one or more spatially precoded data streams, which enables the node B 408 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

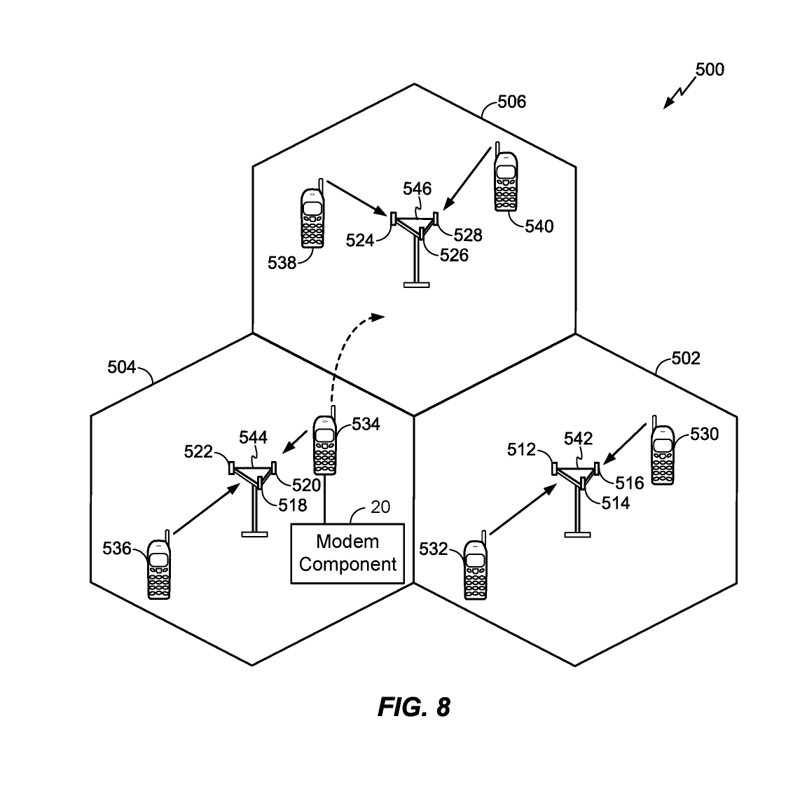

Referring to FIG. 8, an access network 500 in a UTRAN architecture is illustrated. The access network 500 may provide communications for UEs 530, 532, 534, 536, 538, 540, each of which may be an example of the UE 12 (FIG. 1) and include a modem component 20. The multiple access wireless communication system includes multiple cellular regions (cells), including cells 502, 504, and 506, each of which may include one or more sectors. The multiple sectors can be formed by groups of antennas with each antenna responsible for communication with UEs in a portion of the cell. For example, in cell 502, antenna groups 512, 514, and 516 may each correspond to a different sector. In cell 504, antenna groups 518, 520, and 522 each correspond to a different sector. In cell 506, antenna groups 524, 526, and 528 each correspond to a different sector. The cells 502, 504 and 506 may include several wireless communication devices, e.g., UEs, which may be in communication with one or more sectors of each cell 502, 504 or 506. For example, UEs 530 and 532 may be in communication with Node B 542, UEs 534 and 536 may be in communication with Node B 544, and UEs 538 and 540 can be in communication with Node B 546. Here, each Node B 542, 544, 546 is configured to provide an access point to a CN 404 (see FIG. 7) for all the UEs 530, 532, 534, 536, 538, 540 in the respective cells 502, 504, and 506.

As the UE 534 moves from the illustrated location in cell 504 into cell 506, a serving cell change (SCC) or handover may occur in which communication with the UE 534 transitions from the cell 504, which may be referred to as the source cell, to cell 506, which may be referred to as the target cell. Management of the handover procedure may take place at the UE 534, at the Node Bs corresponding to the respective cells, at a radio network controller 406 (see FIG. 7), or at another suitable node in the wireless network. For example, during a call with the source cell 504, or at any other time, the UE 534 may monitor various parameters of the source cell 504 as well as various parameters of neighboring cells such as cells 506 and 502. Further, depending on the quality of these parameters, the UE 534 may maintain communication with one or more of the neighboring cells. During this time, the UE 534 may maintain an Active Set, that is, a list of cells that the UE 534 is simultaneously connected to (i.e., the UTRA cells that are currently assigning a downlink dedicated physical channel DPCH or fractional downlink dedicated physical channel F-DPCH to the UE 534 may constitute the Active Set).

The modulation and multiple access scheme employed by the access network 500 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

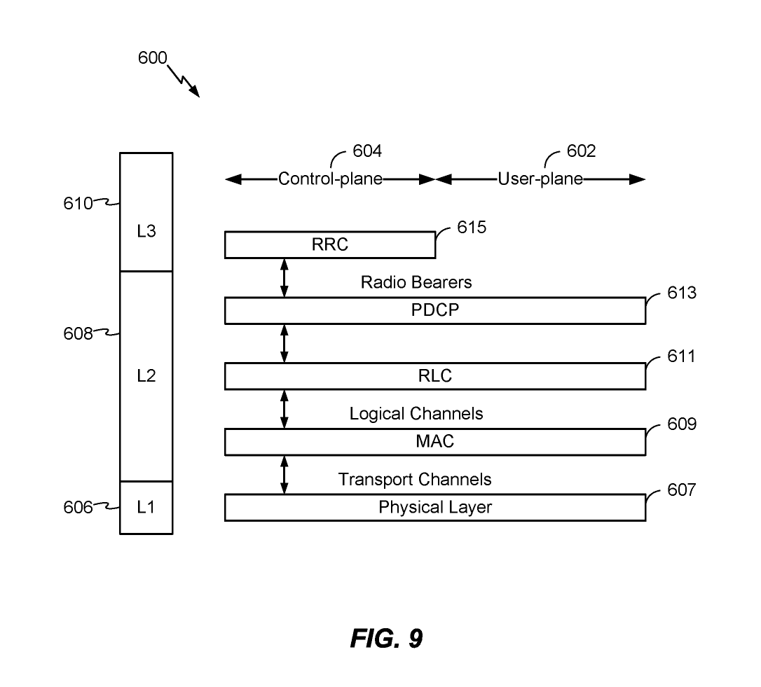

The radio protocol architecture may take on various forms depending on the particular application. An example for an HSPA system will be presented below with reference to FIG. 9.

Referring to FIG. 9 an example radio protocol architecture 600 relates to the user plane 602 and the control plane 604 of a UE or node B/base station. For example, architecture 600 may be included in a UE such as UE 12 (FIG. 1) having a modem component 20. The radio protocol architecture 600 for the UE and node B is shown with three layers: Layer 1 606, Layer 2 608, and Layer 3 610. Layer 1 606 is the lowest layer and implements various physical layer signal processing functions. As such, Layer 1 606 includes the physical layer 607. Layer 2 (L2 layer) 608 is above the physical layer 607 and is responsible for the link between the UE and node B over the physical layer 607. Layer 3 (L3 layer) 610 includes a radio resource control (RRC) sublayer 615. The RRC sublayer 615 handles the control plane signaling of Layer 3 between the UE and the UTRAN. The control plane signaling may include RRC reconfiguration messages, which the UE 12 may validate based on SDU lifetime.

In the user plane, the L2 layer 608 includes a media access control (MAC) sublayer 609, a radio link control (RLC) sublayer 611, and a packet data convergence protocol (PDCP) 613 sublayer, which are terminated at the node B on the network side. Although not shown, the UE may have several upper layers above the L2 layer 608 including a network layer (e.g., IP layer) that is terminated at a PDN gateway on the network side, and an application layer that is terminated at the other end of the connection (e.g., far end UE, server, etc.).

The PDCP sublayer 613 provides multiplexing between different radio bearers and logical channels. The PDCP sublayer 613 also provides header compression for upper layer data packets to reduce radio transmission overhead, security by ciphering the data packets, and handover support for UEs between node Bs. The RLC sublayer 611 provides segmentation and reassembly of upper layer data packets, retransmission of lost data packets, and reordering of data packets to compensate for out-of-order reception due to hybrid automatic repeat request (HARQ). The RLC sublayer 611 may also provide measurements of receiving delay between receipt of RLC data packets or PDU. The MAC sublayer 609 provides multiplexing between logical and transport channels. The MAC sublayer 609 is also responsible for allocating the various radio resources (e.g., resource blocks) in one cell among the UEs. The MAC sublayer 609 is also responsible for HARQ operations.

FIG. 10 is a block diagram of a Node B 710 in communication with a UE 750, where the Node B 710 may be the Node B 408 in FIG. 7, and the UE 750 may be the UE 410 in FIG. 7 or the UE 12 in FIG. 1. The UE 750 may include a modem component 20. Although the modem component 20 is shown in a particular configuration in FIG. 7, the disclosure need not be so limited and the modem component 20 may be implemented in a different configuration and/or as part of one or more of the various components of UE 750. In the downlink communication, a transmit processor 720 may receive data from a data source 712 and control signals from a controller/processor 740. The transmit processor 720 provides various signal processing functions for the data and control signals, as well as reference signals (e.g., pilot signals). For example, the transmit processor 720 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 744 may be used by a controller/processor 740 to determine the coding, modulation, spreading, and/or scrambling schemes for the transmit processor 720. These channel estimates may be derived from a reference signal transmitted by the UE 750 or from feedback from the UE 750. The symbols generated by the transmit processor 720 are provided to a transmit frame processor 730 to create a frame structure. The transmit frame processor 730 creates this frame structure by multiplexing the symbols with information from the controller/processor 740, resulting in a series of frames. The frames are then provided to a transmitter 732, which provides various signal conditioning functions including amplifying, filtering, and modulating the frames onto a carrier for downlink transmission over the wireless medium through antenna 734. The antenna 734 may include one or more antennas, for example, including beam steering bidirectional adaptive antenna arrays or other similar beam technologies.

At the UE 750, a receiver 754 receives the downlink transmission through an antenna 752 and processes the transmission to recover the information modulated onto the carrier. The information recovered by the receiver 754 is provided to a receive frame processor 760, which parses each frame, and provides information from the frames to a channel processor 794 and the data, control, and reference signals to a receive processor 770. The receive processor 770 then performs the inverse of the processing performed by the transmit processor 720 in the Node B 710. More specifically, the receive processor 770 descrambles and despreads the symbols, and then determines the most likely signal constellation points transmitted by the Node B 710 based on the modulation scheme. These soft decisions may be based on channel estimates computed by the channel processor 794. The soft decisions are then decoded and deinterleaved to recover the data, control, and reference signals. The CRC codes are then checked to determine whether the frames were successfully decoded. The data carried by the successfully decoded frames will then be provided to a data sink 772, which represents applications running in the UE 750 and/or various user interfaces (e.g., display). The modem component 20 may receive the decoded frames from receive processor 770 or data sink 772 for performing validation based on SDU lifetime. Control signals carried by successfully decoded frames will be provided to a controller/processor 790. When frames are unsuccessfully decoded by the receiver processor 770, the controller/processor 790 may also use an acknowledgement (ACK) and/or negative acknowledgement (NACK) protocol to support retransmission requests for those frames.

In the uplink, data from a data source 778 and control signals from the controller/processor 790 are provided to a transmit processor 780. The data source 778 may represent applications running in the UE 750 and various user interfaces (e.g., keyboard). Similar to the functionality described in connection with the downlink transmission by the Node B 710, the transmit processor 780 provides various signal processing functions including CRC codes, coding and interleaving to facilitate FEC, mapping to signal constellations, spreading with OVSFs, and scrambling to produce a series of symbols. Channel estimates, derived by the channel processor 794 from a reference signal transmitted by the Node B 710 or from feedback contained in the midamble transmitted by the Node B 710, may be used to select the appropriate coding, modulation, spreading, and/or scrambling schemes. The symbols produced by the transmit processor 780 will be provided to a transmit frame processor 782 to create a frame structure. The transmit frame processor 782 creates this frame structure by multiplexing the symbols with information from the controller/processor 790, resulting in a series of frames. The frames are then provided to a transmitter 756, which provides various signal conditioning functions including amplification, filtering, and modulating the frames onto a carrier for uplink transmission over the wireless medium through the antenna 752.

The uplink transmission is processed at the Node B 710 in a manner similar to that described in connection with the receiver function at the UE 750. A receiver 735 receives the uplink transmission through the antenna 734 and processes the transmission to recover the information modulated onto the carrier. The information recovered by the receiver 735 is provided to a receive frame processor 736, which parses each frame, and provides information from the frames to the channel processor 744 and the data, control, and reference signals to a receive processor 738. The receive processor 738 performs the inverse of the processing performed by the transmit processor 780 in the UE 750. The data and control signals carried by the successfully decoded frames may then be provided to a data sink 739 and the controller/processor, respectively. If some of the frames were unsuccessfully decoded by the receive processor, the controller/processor 740 may also use an acknowledgement (ACK) and/or negative acknowledgement (NACK) protocol to support retransmission requests for those frames.

The controller/processors 740 and 790 may be used to direct the operation at the Node B 710 and the UE 750, respectively. For example, the controller/processors 740 and 790 may provide various functions including timing, peripheral interfaces, voltage regulation, power management, and other control functions. The computer readable media of memories 742 and 792 may store data and software for the Node B 710 and the UE 750, respectively. A scheduler/processor 746 at the Node B 710 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining a receiving delay between receiving a first protocol data unit (PDU) and receiving a last PDU of a reconfiguration message service data unit (SDU);
comparing the receiving delay with an SDU lifetime; and
validating the reconfiguration message SDU based on the comparison of the receiving delay with the SDU lifetime.

2. The method of claim 1, wherein validating the reconfiguration message SDU comprises rejecting the reconfiguration message SDU when the receiving delay exceeds the SDU lifetime.

3. The method of claim 2, wherein rejecting the reconfiguration message SDU comprises generating a failure message.

4. The method of claim 1, wherein validating the reconfiguration message SDU comprises accepting the reconfiguration message SDU when the receiving delay is less than the SDU lifetime.

5. The method of claim 4, further comprising implementing a configuration change indicated by the reconfiguration message SDU during the SDU lifetime.

6. The method of claim 4, further comprising determining whether to honor or disregard an activation time of the reconfiguration message SDU based on the receiving delay.

7. The method of claim 6, wherein disregarding the activation time comprises immediately implementing the reconfiguration message SDU despite an activation time.

8. The method of claim 1, wherein the SDU lifetime is a time that a network that transmitted the reconfiguration message SDU allows a receiving wireless device to implement a change indicated by the reconfiguration message.

9. The method of claim 1, further comprising adding a guard interval for the SDU to the SDU lifetime.

10. The method of claim 1, wherein the SDU lifetime is between 6 and 8 seconds.

11. An apparatus for wireless communication, comprising:
means for determining a receiving delay between receiving a first protocol data unit (PDU) and receiving a last PDU of a reconfiguration message service data unit (SDU);
means for comparing the receiving delay with an SDU lifetime; and
means for validating the reconfiguration message SDU based on the comparison of the receiving delay with the SDU lifetime.

12. The apparatus of claim 11, wherein the means for validating the reconfiguration message SDU comprise means for rejecting the reconfiguration message SDU when the receiving delay exceeds the SDU lifetime.

13. The apparatus of claim 12, wherein the means for rejecting the reconfiguration message SDU comprise a transmitter configured to transmit a failure message.

14. The apparatus of claim 11, wherein the means for validating the reconfiguration message SDU comprise means for accepting the reconfiguration message SDU when the receiving delay is less than the SDU lifetime.

15. The apparatus of claim 14, further comprising means for implementing a configuration change indicated by the reconfiguration message SDU during the SDU lifetime.

16. The apparatus of claim 14, further comprising means for disregarding an activation time of the reconfiguration message SDU based the receiving delay.

17. The apparatus of claim 16, wherein the means for disregarding are configured to immediately implement the reconfiguration message SDU despite an activation time.

18. The apparatus of claim 11, wherein the SDU lifetime is a time that a network that transmitted the reconfiguration message SDU allows the apparatus to implement a change indicated by the reconfiguration message.

19. The apparatus of claim 11, wherein the means for comparing is configured to add a guard interval for the SDU to the SDU lifetime.

20. The apparatus of claim 11, wherein the SDU lifetime is between 6 and 8 seconds.

21. A computer-readable medium storing computer executable code, comprising code for:
determining a receiving delay between receiving a first protocol data unit (PDU) and receiving a last PDU of a reconfiguration message service data unit (SDU);
comparing the receiving delay with an SDU lifetime; and
validating the reconfiguration message SDU based on the comparison of the receiving delay with the SDU lifetime.

22. The computer-readable medium of claim 21 further comprising code for rejecting the reconfiguration message SDU when the receiving delay exceeds the SDU lifetime.

23. The computer-readable medium of claim 22, wherein the code for rejecting the reconfiguration message SDU comprises code for transmitting a failure message.

24. The computer-readable medium of claim 21 further comprising code for accepting the reconfiguration message SDU when the receiving delay is less than the SDU lifetime.

25. The computer-readable medium of claim 24 further comprising code for disregarding an activation time of the reconfiguration message SDU based the receiving delay.

26. The computer-readable medium of claim 25, wherein the code for disregarding comprises code for immediately implementing the reconfiguration message SDU despite an activation time.

27. An apparatus for wireless communication, comprising:
at least one processor; and
a memory coupled to the at least one processor,
wherein the at least one processor is configured execute instructions stored in the memory to:
determine a receiving delay between receiving a first protocol data unit (PDU) and receiving a last PDU of a reconfiguration message service data unit (SDU);
compare the receiving delay with an SDU lifetime; and
validate the reconfiguration message SDU based on the comparison of the receiving delay with the SDU lifetime.

28. The apparatus of claim 27, wherein the at least one processor is further configured to:
reject the reconfiguration message SDU when the receiving delay exceeds the SDU lifetime; and
transmit a failure message indicating that the reconfiguration message SDU is invalid.

29. The apparatus of claim 27, wherein the at least one processor is further configured to accept the reconfiguration message SDU when the receiving delay is less than the SDU lifetime.

30. The apparatus of claim 29, wherein the at least one processor is further configured to:
compare an activation time of the reconfiguration message SDU with the receiving delay; and
disregard the activation time when the receiving delay is greater than the activation time.
